(19) United States
(12) Patent Application Publication
(10) Pub. No.: US 2009/0146632 A1
(43) Pub. Date: Jun. 11, 2009

(54) SOFT START OF A SWITCHED SECONDARY CONTROL CIRCUIT FOR A SWITCHED MODE POWER SUPPLY

(75) Inventor: Paul Johannes Marie Julicher, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,767

(22) PCT Filed: Nov. 21, 2005
(86) PCT No.: PCT/IB05/53840

§ 371 Date: May 21, 2007

(30) Foreign Application Priority Data
Nov. 24, 2004 (EP) 04106039.3

(51) Int. Cl. G05F 1/00

(52) U.S. Cl. 323/288

(57) ABSTRACT

Usually when switched secondary control is used to regulate output voltages in a flyback converter, high peak currents through the secondary switch occur during startup. Traditional soft-start methods cannot be applied to limit these peak currents. With the inventive control circuit and method, current limiting during startup is achieved by measuring the magnetic flux in the fly-back transformer, and by advancing the time instant at which current flow through the secondary switch (11) starts with respect to the end of the flyback stroke in dependence of the magnetic flux in the transformer.

The present invention relates to a control circuit for a secondary side post regulation circuit coupled to a switched mode power supply and to a method for controlling such a secondary side post regulation circuit.

Flyback switched mode power supplies, or flyback converters, are often used to deliver multiple output voltages, which for example are used for microprocessors requiring a precise supply voltage of 3.3V or less together with a conventional supply voltage of 5V.

A flyback converter with multiple outputs usually includes a transformer with a primary side winding and a secondary side winding for each one of the multiple outputs. The primary side winding is coupled to a switching transistor, which is controlled by a main controller. One of the output voltages is regulated by the main controller in a main control loop, while all other outputs may track the regulated output via the coupling of the various transformer windings. Often, however, secondary side post regulation is needed in order to achieve the desired accuracy of these other outputs. Several post regulation methods are widely used, such as the linear regulator or the buck down converter.

With flyback converters, a seldom-used post regulation method is the so-called switched secondary control. This regulation method has advantages compared to the traditional methods, among which is a higher efficiency. But on the other hand, the application of switched secondary control in flyback converters is difficult because it influences the current division in the various transformer windings and thereby the cross-loads of the various outputs. One of the biggest problems encountered is the start up of the power supply or the start up (enabling) of a secondary controlled output. During a start up phase, the peak currents flowing in the secondary controlled outputs can become tremendous and destroy the semiconductor switches placed in those outputs. In order to survive the high peak currents during a start-up sequence, the semiconductor switches used in such switched secondary control circuits are usually over dimensioned.

An example of a multi-output switching power supply, which however is a forward converter and not a flyback converter, is disclosed in US 2004/0046536 A1. The disclosed power supply includes a Pulse Width Modulation (PWM) regulator circuit in cascade upstream of each output to receive, as an input, a square wave voltage signal with a predetermined duty cycle. The regulator circuit includes an auxiliary switching device for modulating the duty cycle of the input signal and to supply, as an output, a regulated D.C. voltage. The PWM regulator circuit is controlled by a control circuit, which includes a ramp signal generator being synchronized with the duty cycle of the input signal. The ramp signal generator is connected to the non-inverting input of a comparator having an inverting input for receiving a signal indicative of the error in the regulator voltage output. The ramp-signal generator is arranged to trigger the generation of the ramp signal at a moment coinciding with the leading edge of the voltage signal input to the regulator circuit. The resulting driving signal for the switching device has a duty cycle less than or equal to the duty cycle of the signal input to the regulator circuit, with modulation of the leading edge over time and with the trailing edges coinciding.

An object of the present invention is to provide an improved control circuit for a switched secondary side post regulation circuit coupled to a flyback switched mode power supply, which control circuit limits the peak currents during start up of the power supply or the secondary controlled output, so that semiconductor switches used for the secondary controlled output do not need to be over dimensioned.

This and other objects are achieved by the provision of a control circuit for a secondary side post regulation circuit according to claim 1 and a method for controlling such a secondary side post regulation circuit according to claim 9. Preferred embodiments of the present invention are defined in the dependent claims.

More specifically, a control circuit is provided according to the present invention for controlling a secondary side post regulation circuit coupled to a switched mode power supply including a transformer. The secondary side post regulation circuit is arranged to act on a cyclic secondary voltage from the transformer and comprises a switching device adapted to allow current flow during at least a portion of the secondary voltage cycle in response to a control signal from the control circuit. The control circuit is characterized in that it is arranged to measure a magnetic flux in said transformer and, during a start-up phase of the secondary side post regulation circuit, to gradually increase said portion of the secondary voltage cycle by advancing the time instant at which said current flow starts with respect to the end of said cycle in dependence of said magnetic flux in the transformer.

By gradually moving the turn on instant of the switching device with respect to the end of said cycle towards the beginning of the cycle, the invention makes it possible to eliminate any high peak currents present during the start up of a secondary controlled output of a flyback converter. This is because at the end portion of the cycle, the magnetic energy present in the transformer core has decreased to relatively small levels, which effectively limits the peak currents when the switching device is turned on. As a result, the switching device used does not need to be over dimensioned to survive a start up sequence. Second, overshoot in the secondary controlled output voltage during start up can be decreased or even eliminated. Third, by controlling the switching of the switching device in dependence of the magnetic flux in the transformer, transients in the main feedback loop of the power supply during a start up of the secondary controlled output may be minimized.

According to another embodiment of the invention, the control circuit is during the start-up phase arranged to gradually change operation of the secondary side post regulation circuit from a leading edge mode, wherein the turn-on instant of the switching device is modulated, to operation in a trailing edge mode, wherein the turn-off instant of the switching device is modulated. By gradually switching over to trailing edge operation during the start up, the best possible cross-load behavior of the power supply is obtained during following steady-state operation.

According to another embodiment of the invention, the control circuit comprises steady-state control circuitry arranged to provide a steady-state control signal to the switching device, and soft-start control circuitry arranged to provide a soft-start control signal to the switching device according to which the switching device is adapted to provide said advancing of the time instant at which said current flow starts with respect to the end of said cycle. This separation of the control circuit into a steady-state control circuitry and a soft-start control circuitry allows simple and logical circuit construction. Further, these two circuitries may be arranged to operate more or less independently of each other.

Preferably, said soft-start control circuitry is adapted to modulate the turn-on instant of the switching device, so that the secondary side post regulation circuit operates in a leading edge mode during the start-up phase, and said steady-state control circuitry is adapted to modulate the turn-off instant of the switching device so that the secondary side post regulation circuit operates in a trailing edge mode during steady state operation.

In another embodiment, the soft-start control circuitry comprises a comparator arranged to compare a voltage image of said magnetic flux present in the transformer with a soft-start voltage signal, which is adapted to have a voltage level which during said start-up phase of the secondary side post regulation circuit is increasing gradually until it is above a highest level of said voltage image, and to emit said soft-start control signal in dependence on the outcome of the comparison. By measuring the magnetic flux in the transformer and comparing it to a gradually increasing voltage level, it may be secured that the level of the current flow through the switching device when being turned on will be acceptable. Preferably, the soft-start control signal is adapted to turn on the switching device when the level of said voltage image becomes lower than said soft-start voltage signal level. The voltage image can further be provided by means of an integration circuitry arranged to integrate a voltage across a winding of said transformer.

In still another embodiment, the control circuit further comprises an AND gate adapted to receive said steady-state control signal at its first input and said soft-start control signal at its second input and to output the result of the AND operation for controlling switching of said switching device. Hence, by means of this AND gate, the separate steady-state control circuitry and soft-start control circuitry may operate together in combination in order to control the switching of the switching device.

According to another aspect of the present invention, a method for controlling a secondary side post regulation circuit coupled to a switched mode power supply including a transformer, wherein the secondary side post regulation circuit is arranged to act on a cyclic secondary voltage from the transformer and comprises a switching device adapted to allow current flow during at least a portion of the secondary voltage cycle in response to a control signal from the control circuit, comprises the acts of measuring a magnetic flux in said transformer and, during a start-up phase of the secondary side post regulation circuit, gradually increasing said portion of the secondary voltage cycle by advancing the time instant at which said current flow starts with respect to the end of said cycle in dependence of said magnetic flux in the transformer.

Further features of, and advantages with, the present invention will become apparent when studying the appended claims and the following description.

A preferred embodiment of the present invention will now be described in more detail with reference to the accompanying drawings, in which

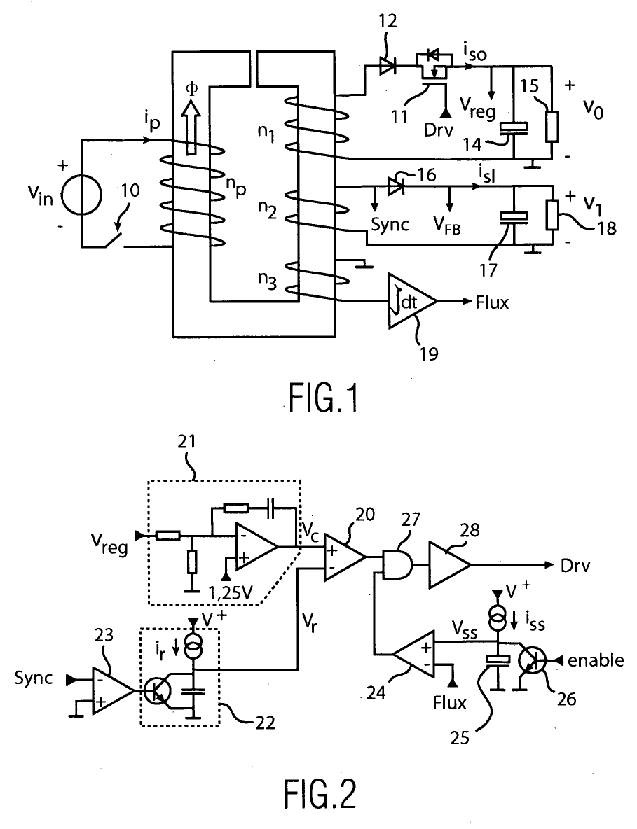

FIG. 1 is a schematic electrical circuit diagram showing a simplified switched mode power supply (SMPS) with two outputs, wherein a secondary side post regulation (SSPR) circuit is arranged to regulate one of the outputs in accordance with control from a control circuit according to an embodiment of the present invention;

FIG. 2 is a schematic electrical circuit diagram showing one embodiment of a control circuit according to the present invention, which control circuit is arranged to control the SSPR circuit of the SMPS shown in FIG. 1;

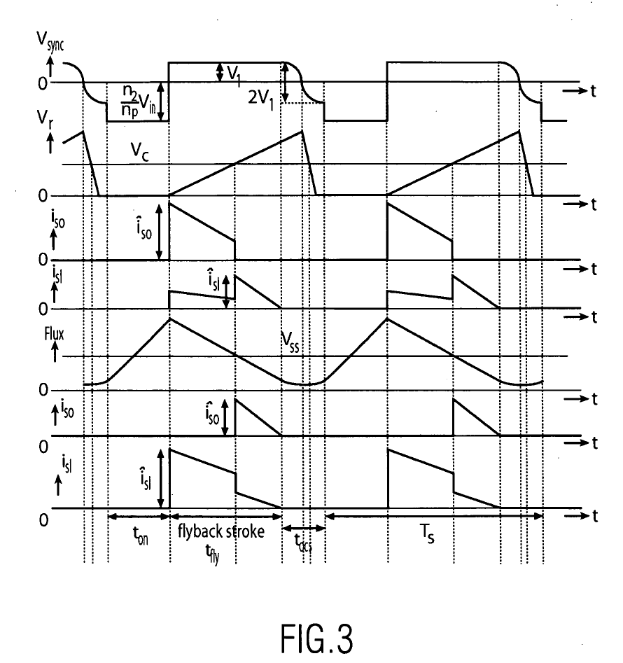

FIG. 3 is a signal graph showing waveforms of various signals in the SSPR circuit and the control circuit in FIGS. 1 and 2, wherein the upper four waveforms illustrate steady state operation of the SSPR circuit whereas the bottom three waveforms illustrate operation during start up of the SSPR circuit;

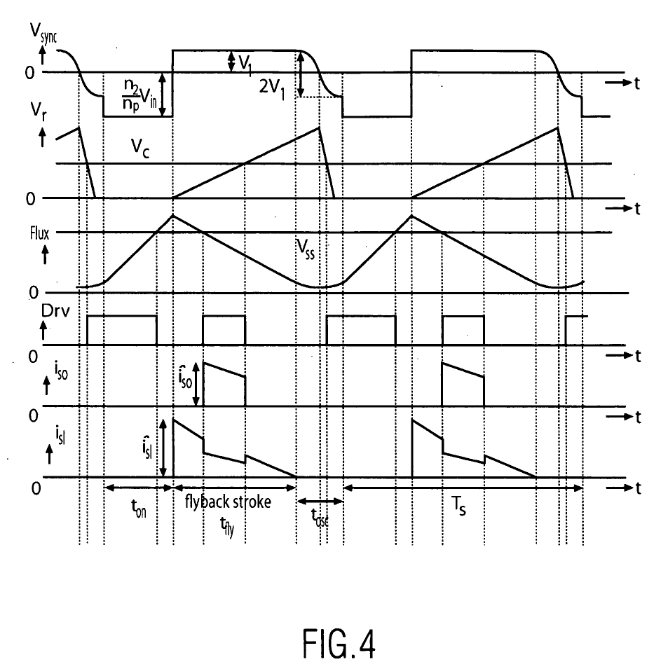

FIG. 4 is a signal graph showing waveforms of various signals in the SSPR circuit and the control circuit in FIGS. 1 and 2, the graph illustrating mixed mode operation of the SSPR circuit.

In FIG. 1, a switched mode power supply (SMPS) is shown in a simplified manner. The SMPS comprises a transformer with a primary winding nₚ and secondary windings n₁, n₂ and n₃ wound around a core (the references nₚ, n₁, n₂ and n₃ also denote the number of turns of each of the windings). On the primary side of the SMPS, an input voltage Vᵢₙ may be applied, resulting in a primary current iₚ each time a primary switch 10, e.g. in the form of a MOSFET transistor, is turned on by a main controller (not shown).

The secondary winding n₁ is coupled to a secondary output having an output voltage V₀ across an output capacitor 14 and an output load 15. The output voltage V₀ is regulated by a secondary side post regulation (SSPR) circuit, which comprises diode 12 and a secondary switch 11, here in the form of a MOSFET transistor. The SSPR circuit further comprises a control circuit, depicted in FIG. 2, according to the invention, which is arranged to control switching of the secondary switch 11.

The secondary winding n₂ is coupled to a main output having an output voltage V₁ which is regulated by the main controller in a main control loop, wherein a feedback voltage V_{FB} is feedbacked to the main controller. A diode 16, a capacitor 17, and an output load 18 of the main output correspond to the diode 12, the capacitor 14 and the load 15, respectively, of the secondary controlled output circuit.

The secondary transformer winding n₃ is coupled to an integrator 19, which is arranged to integrate the voltage across the winding n₃ such that a measure of a magnetic flux Φ in the transformer core is achieved, and to output a resulting voltage image Flux of the magnetic flux Φ. This voltage image Flux is provided to the control circuit shown in FIG. 2. Alternatively, the magnetic flux in the transformer core may be measured in another way, for example by means of a hall effect sensor placed within the air gap of the transformer core.

The SMPS in FIG. 1 is assumed to operate as a flyback converter. Hence, no current flows in the secondary windings n₁ and n₂ when the primary switch 10 is turned on. Instead, a magnetic flux Φ is built up in the core by the primary current iₚ during each time period that the primary switch is turned on. During each following time period when the primary switch 10 is turned off, during the so-called flyback stroke, the built up flux Φ results in secondary voltages across the secondary windings n₁, n₂ and n₃, allowing a secondary current iₛ₀ to flow through the secondary switch 11 when turned on and a secondary current iₛ₁ to flow towards the main output V1.

FIG. 2 shows one embodiment of a controller circuit according to the invention. The controller circuit comprises a steady-state control circuitry, which is arranged to provide a steady-state control signal to the switching device 11 during normal (steady-state) operation of the SSPR circuit. The controller circuit also comprises a soft-start control circuitry, which is arranged to provide a soft-start control signal to the switching device 11.

The steady-state control circuitry comprises a pulse width modulation (PWM) comparator 20 comparing input voltages V_{c} and Vᵣ. The first input V_{c} is the output voltage of an error amplifier 21, which compares the output voltage V₀, measured in the point V_{reg} in FIG. 1, to a 1.25V reference voltage. The second input Vᵣ is a triangle signal, which is synchronized to the switching period of the SMPS. This synchronization is achieved by a Sync signal, obtained as the voltage across the main secondary winding n₂ (see FIG. 1), which is fed to a comparator 23. This comparator 23 is arranged to control a Vᵣ ramp generation stage 22, in such a way that a linear rising ramp starts at the beginning of each flyback stroke (t_{fly} in FIG. 3).

Alternatively, the Sync signal could be the voltage across the secondary winding n₁ instead, but obtaining the sync signal from a normal flyback output, for example from main output V1, minimizes ringing in the sync signal due to the switching of switch 11. This ringing is less present in the other transformer windings.

The soft-start control circuitry comprises a flux comparator 24 arranged to compare the voltage image Flux of the magnetic flux Φ present in the transformer with a soft-start voltage signal Vₛₛ. The soft-start voltage signal Vₛₛ is generated by means of a current source providing a current iₛₛ to slowly charge a capacitor 25 such that the soft-start voltage signal Vₛₛ rises slowly. A transistor 26 is arranged to discharge the capacitor 25 when an enable signal is high in order to switch off the secondary controlled output V₀.

An AND gate 27 is arranged to receive the steady-state control signal from the PWM comparator 20 at its first input and the soft-start control signal from the flux comparator 24 at its second input and to output the result of the AND operation for controlling switching of the switching device 11 via an output driver 28.

Operation of the control circuit is as follows:

During steady-state operation, the SSPR circuit operates in a trailing edge mode (upper four waveforms in FIG. 3). In steady-state operation, the current iₛₛ has charged the capacitor 25 to a level being higher than the Flux signal. Therefore, the output of the flux comparator 24 is high, and the AND gate 27 is enabled. As a result, the output of the PWM comparator comparing V_{c} and Vᵣ is fed directly to the output driver 28, controlling the switching device 11.

The comparison of the ramp Vᵣ with the error signal V_{c} by the PWM comparator 20 ensures the switching device 11 is already turned on before the beginning of each flyback stroke and determines the conduction time of this switching device within the flyback stroke. The turning on of switching device 11 before each flyback stroke is possible because diode 12 blocks outside each flyback stroke.

Via controlling of the conduction time of the switching device 11, the output voltage V₀ can be regulated such that the switching device 11 conducts during the first part of each flyback stroke, resulting in a cut-off of the switch current iₛ₀ somewhere within the flyback stroke (see FIG. 3).

The switching device 11 can be used also to switch off the output V₀ (called standby mode). This is achieved by pulling the enable signal high as stated above, thereby discharging the capacitor 25 and pulling the Vₛₛ signal below the Flux signal. Now the AND gate is disabled, and the driver switches off the switching device 11 permanently.

With the output V₀ switched off, the output capacitor 14 is fully discharged and the error amplifier 21 detects a too low output voltage. Now V_{c} is above Vᵣ, and the output of the PWM comparator 20 is continuously high, attempting to turn on the switch continuously.

If there was no soft-start circuitry, but instead the enable signal was pulled high at turn-on of the SSPR circuit and fed directly into the AND gate 27, the switching on of the output V₀ again would result in a continuously conducting switching device 11, since both AND gate inputs would be continuously high. Because V₀ is still zero, almost all energy stored in the transformer is delivered to this output, resulting in very high peak currents îₛ₀ flowing through the switching device 11. These peak currents are limited effectively by the soft-start circuitry of the inventive control circuit.

The operation of the soft-start circuitry is as follows:

During start-up of the SSPR circuit, use is made of the fact that the upper input of the AND gate 27 remains continuously high. With the soft-start circuitry connected to the lower AND gate input, it is possible to still switch the switching device 11 off. Because the enable signal has been pulled low at start-up, the current source iₛₛ is enabled to slowly charge the capacitor 25. Therefore, the Vₛₛ voltage rises slowly. This Vₛₛ voltage is compared to the Flux signal by the flux comparator 24, which as stated above is a voltage image of the magnetic flux Φ inside the transformer. The setup of the integrator 19 is such that the Flux signal is always slightly above zero.

Now, the comparison of the Vₛₛ and Flux signals results in the soft-start control signal in the form of a PWM drive signal which ensures the switching device 11 is operated in leading edge mode. In the beginning of the start up, the switching device 11 is turned on only at the very end of the flyback stroke. Because at the end of the flyback stroke, the transformer energy has already decreased to small levels, the resulting peak current îₛ₀ flowing through the switching device 11 is effectively limited (see FIG. 3). As the soft start proceeds, the conduction time of the switching device 11 increases, so it is turned on earlier within the flyback stroke. In this way, the current iₛ₀ through the switching device 11 rises smoothly.

As the soft start proceeds, of course the output voltage V₀ rises. It is possible that V₀ reaches its steady state level while the soft-start is still active. Then, both the error amplifier 21 and the flux comparator 24 determine the conduction time of the switching device 11. This operation is called mixed mode operation. An example of this mixed mode operation is shown in FIG. 4. Finally, when the current source iₛₛ has charged the capacitor 25 to a level exceeding the peak value of the Flux signal, the soft-start is ended and the lower input of the AND gate 27 is continuously high. Now the SSPR circuit has returned to normal operation, as treated before. Therefore, each time the output V₀ is turned on, the soft-start is automatically activated.

Compared to a start up sequence without soft-start, the current through the switching device is effectively limited by the inventive control circuit. Overshoot in the secondary output voltage is also decreased considerably. Further, since the turn-on of the secondary switching device is initiated by the intersection of the flux signal (being a voltage image of the transformer flux) with the Vₛₛ signal (see FIG. 3), the peak current îₛ₀ is tightly controlled, independent of changes in the on-time of the primary switch 10.

This behavior cannot be obtained with a more conventional soft-start scheme, which initiates the switching device 11 by the intersection of a triangular shaped signal similar to Vr (FIG. 2,3) with a slowly decreasing Vss signal. With this conventional scheme, the soft-start is partly overruled due to the influence of the soft-start of the secondary controlled output on the main control loop, which tends to increase the on-time of the primary switch 10. As a result, the peak current îₛ₀ is not tightly controlled, and soft-start operation is less optimal.

The above description exclusively treats a start-up phase of the secondary controlled output V₀. Similar behavior also occurs when the total power supply is switched on. Then, referring to FIG. 1, output V₁ will start to rise. Because the logic circuits in the secondary control need to be fed from a secondary supply voltage, V₀ remains zero at first (the switching device 11 remains off because the logic supply voltage is too low). In this situation, a switch being part of the logic (not shown in FIG. 1) may assure the soft-start capacitor 25 is kept in a discharged state. After a while, when the start-up of the power supply proceeds, the supply voltage feeding the secondary control has become high enough, and the secondary control circuit starts operating. Now the fore mentioned switch is opened and the (empty) soft-start capacitor 25 is charged from current source iₛₛ. This assures that the secondary output voltage V₀ builds up while the peak current îₛ₀ is tightly controlled by the soft-start. In this way, it is assured that the secondary controlled output voltage V₀ always builds up via a soft-start sequence.

The present invention is preferably applied to flyback converters, but may also be applied to other topologies having multiple outputs, such as a fly-forward converter.

It is to be understood that the present invention defined by the appended claims may be implemented in a variety of ways by people skilled in the art without departing from the spirit and scope of the invention.

1. A control circuit for a secondary side post regulation circuit coupled to a switched mode power supply including a transformer, wherein the secondary side post regulation circuit is arranged to act on a cyclic secondary voltage from the transformer and comprises a switching device (11) adapted to allow current flow during at least a portion of the secondary voltage cycle in response to a control signal from the control circuit, characterized in that
the control circuit is arranged to measure a magnetic flux in said transformer and, during a start-up phase of the secondary side post regulation circuit, to gradually increase said portion of the secondary voltage cycle by advancing the time instant at which said current flow starts with respect to the end of said cycle in dependence of said magnetic flux in the transformer.

2. A control circuit according to claim 1, which control circuit during the start-up phase is arranged to gradually change operation of the secondary side post regulation circuit from a leading edge mode, wherein the turn-on instant of the switching device (11), i.e. when said current flow starts with respect to the end of said cycle, is modulated, to operation in a trailing edge mode, wherein the turn-off instant of the switching device is modulated.

3. A control circuit according to claim 1, said control circuit comprising:
steady-state control circuitry (20,21,22,23) arranged to provide a steady-state control signal to the switching device (11), and
soft-start control circuitry (24,25,26) arranged to provide a soft-start control signal to the switching device (11) according to which the switching device is adapted to provide said advancing of the time instant at which said current flow starts with respect to the end of said cycle.

4. A control circuit according to claim 3, wherein said soft-start control circuitry (24,25,26) is adapted to modulate the turn-on instant of the switching device (11), so that the secondary side post regulation circuit operates in a leading edge mode during the start-up phase, and said steady-state control circuitry (20,21,22,23) is adapted to modulate the turn-off instant of the switching device (11) so that the secondary side post regulation circuit operates in a trailing edge mode during steady state operation.

5. A control circuit according to claim 3, wherein the soft-start control circuitry (24,25,26) comprises:
a comparator (24) arranged to compare a voltage image of said magnetic flux present in the transformer with a soft-start voltage signal, which is adapted to have a voltage level which during said start-up phase of the secondary side post regulation circuit is increasing gradually until it is above a highest level of said voltage image, and to emit said soft-start control signal in dependence on the outcome of the comparison.

6. A control circuit according to claim 5, wherein the soft-start control signal is adapted to turn on the switching device (11) when the level of said voltage image becomes lower than said soft-start voltage signal level.

7. A control circuit according to claim 5, wherein said voltage image is provided by means of an integration circuitry (19) arranged to integrate a voltage across a winding of said transformer.

8. A control circuit according to claim 3, further comprising an AND gate (27) adapted to receive said steady-state control signal at its first input and said soft-start control signal at its second input and to output the result of the AND operation for controlling switching of said switching device (11).

9. A method for controlling a secondary side post regulation circuit coupled to a switched mode power supply including a transformer, wherein the secondary side post regulation circuit is arranged to act on a cyclic secondary voltage from the transformer and comprises a switching device (11) adapted to allow current flow during at least a portion of the secondary voltage cycle in response to a control signal from the control circuit, the method comprising the acts of:
measuring a magnetic flux in said transformer and,
during a start-up phase of the secondary side post regulation circuit, gradually increasing said portion of the secondary voltage cycle by advancing the time instant at which said current flow starts with respect to the end of said cycle in dependence of said magnetic flux in the transformer.
